(19) United States
(12) Patent Application Publication
(10) Pub. No.: US 2010/0215467 A1
(43) Pub. Date: Aug. 26, 2010

(54) Cargo Transport System and Method for Loading and Transporting Goods

(76) Inventor: James C. Marshall, Santa Cruz, CA (US)

Correspondence Address: MICHAEL A. GUTH, 2-2905 EAST CLIFF DRIVE, SANTA CRUZ, CA, 95062, US

(21) Appl. No.: 12/690,163

(22) Filed: Jan. 20, 2010

Related U.S. Application Data
(60) Provisional application No. 61/205,564, filed on Jan. 20, 2009.

(51) Int. Cl. B60P 1/00; B60P 1/64; B60P 1/46

(52) U.S. Cl. 414/540; 410/52; 410/67

(57) ABSTRACT

A system and method of loading and delivering goods which may include rolling trays adapted to roll into a truck trailer. The truck trailer may have rails at different heights allowing for the high density packing of trays within the trailer. The trailer may have a lift mechanism with rails which allows rolling trays to be placed onto the rails, or to be rolled onto elevated rails off of mating rails. The lift mechanism may be adapted to raise the rolling trays to different heights associated with the rails within the trailer.

### CROSS-REFERENCE TO RELATED APPLICATIONS

This application claims priority to U.S. Provisional Patent Application No. 61/205,564 to Marshall, filed Jan. 20, 2009, which is hereby incorporated by reference in its entirety.

### BACKGROUND

1. Field of the Invention

This invention relates to transportation of goods, and more specifically to a tray and truck system adapted for streamlined loading and distribution.

2. Description of Related Art

Typically, goods are distributed from centralized locations. These centralized locations may include warehouses, ports, and other areas in which goods are aggregated. Large trucks are often used to ship products from the centralized farm to local retailers. Most overland shipping is accomplished using a tractor/trailer combination.

Goods are often prepared for shipping by being loaded by hand onto the floor of a trailer, after which wooden boards are placed above the top of the first row of goods suspended on supports on the insides of the trailers. After the boards are laid in, a second row of goods may be placed upon the boards, and this process may be repeated until the rows reach the height of the inside of the trailer. Such a process is very time consuming, and it may take a crew of workers four hours to load a single trailer.

Another method for loading trailers is to simply pile goods upon each other in the trailer. This may be effective in the case of a load of boxed goods wherein all of the boxes are identical, it is not effective for unboxed goods, and also not effective for mixed goods.

It is clear that such a labor intensive method of loading a trailer also would involve a reciprocal effort for unloading. However, deliveries are usually made with a tractor/trailer combination driven by a single driver without a second person aboard. Thus, there may not be sufficient manpower to unload the trailer without the assistance of personnel at the delivery site, which may not be available. Also, in the case where the truck is to deliver to a variety of destinations, the cargo to be dropped off at each destination may be difficult to distinguish once loaded, making the individual deliveries difficult.

What is called for is a system and method for easily loading trucks with trays of goods to be delivered. What is also called for is a system which is compatible with methods for handling goods at the central distribution center.

### SUMMARY

A system and method of loading and delivering goods which may include rolling trays adapted to roll into a truck trailer. The truck trailer may have rails at different heights allowing for the high density packing of trays within the trailer. The trailer may have a lift mechanism with rails which allows rolling trays to be placed onto the rails, or to be rolled onto elevated rails off of mating rails. The lift mechanism may be adapted to raise the rolling trays to different heights associated with the rails within the trailer.

### BRIEF DESCRIPTION OF THE DRAWINGS

FIG. 1 is a sketch of a rolling tray according to some embodiments of the present invention.

FIG. 2 is an illustration of a trailer with a tray within it according to some embodiments of the present invention.

FIG. 3 is a partial cutaway rear view of a trailer according to some embodiments of the present invention.

FIG. 4 is a rear view of a trailer according to some embodiments of the present invention.

FIG. 5 is a cutaway side view of a trailer according to some embodiments of the present invention.

FIG. 6 is a cutaway top view of a trailer according to some embodiments of the present invention.

FIG. 7 is a top view of a tray according to some embodiments of the present invention.

FIG. 8 is an end view of a tray according to some embodiments of the present invention.

FIG. 9 is a side view of a tray according to some embodiments of the present invention.

FIG. 10 is a sectional view of a tray according to some embodiments of the present invention.

FIG. 11 is a sectional view of a tray according to some embodiments of the present invention.

FIG. 12 is a sectional view of a tray according to some embodiments of the present invention.

FIG. 13 is an illustration of a trailer being loaded according to some embodiments of the present invention.

FIG. 14 is an illustration of a loading frame according to some embodiments of the present invention.

FIG. 15 is a partial cutaway view of a tray secured in place according to some embodiments of the present invention.

FIG. 16 is a view of removable rails inside a side door according to some embodiments of the present invention.

FIG. 17 is a partial cutaway view of a locking mechanism for a removable rail according to some embodiments of the present invention.

### DETAILED DESCRIPTION

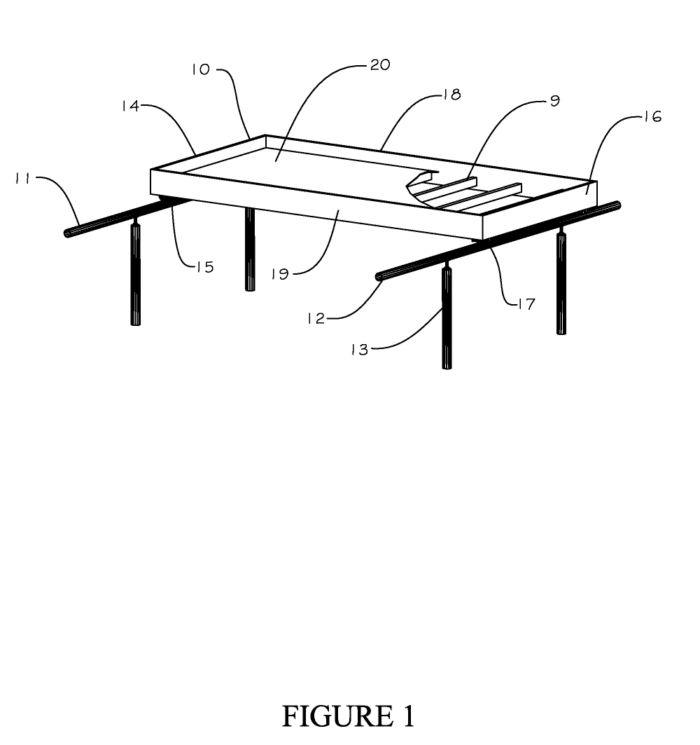

In some embodiments of the present invention, as seen in FIG. 1, a rolling tray 10 is adapted to roll on rails 11, 12. The tray 10 may be of sufficient strength and rigidity to support large loads across the span between the rails 11, 12. The rails 11, 12 may be held in a raised position by supports 13. The trays 10 may be rectangular with long sides 18, 19 and short sides 14, 16. The floor 20 of the tray 10 may be of a metal mesh with structural supports 9 underneath.

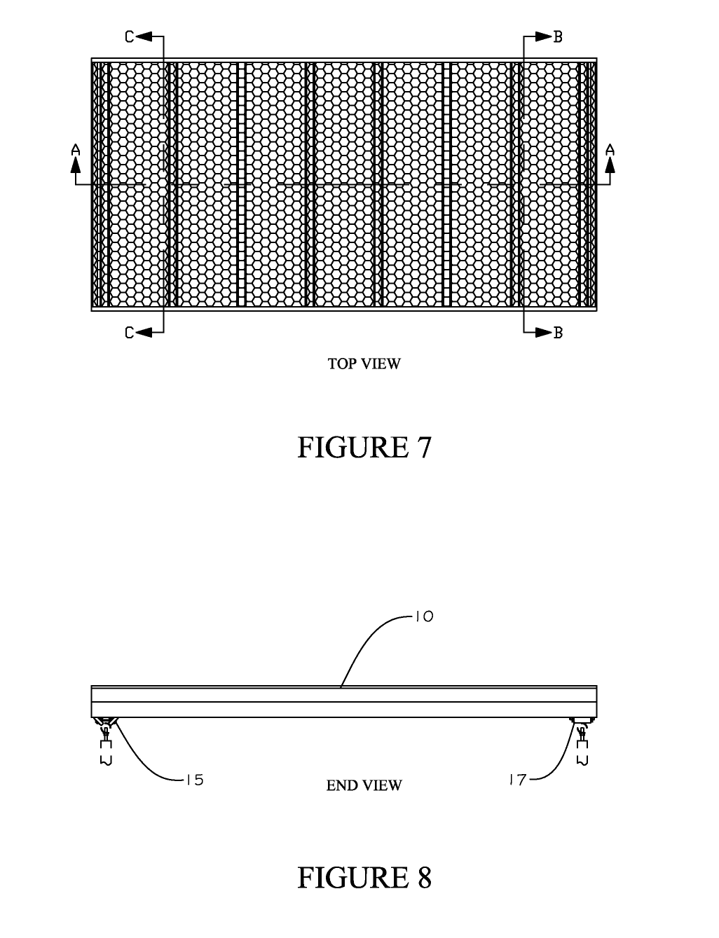

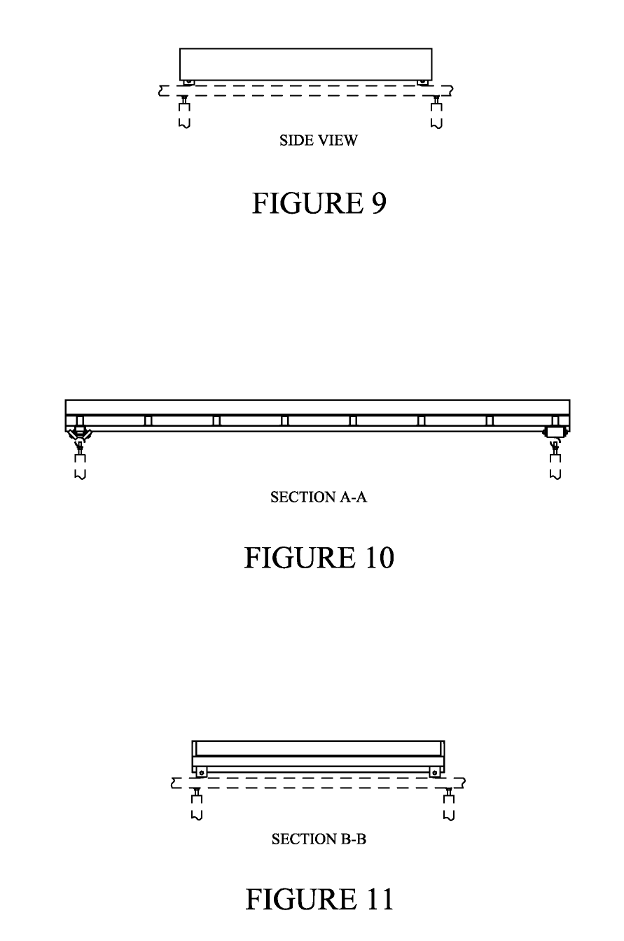

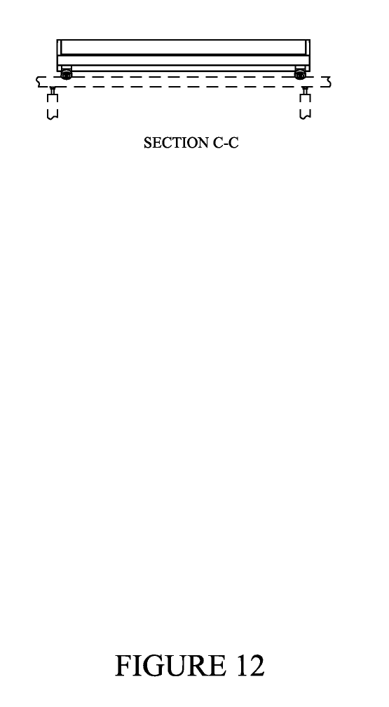

In some embodiments, as also seen in FIGS. 7-12, the tray 10 may be adapted to roll along the rails 11, 12 and also be constrained from motion in a direction perpendicular to the rails 11, 12. Guide rollers 15 are adapted to constrain this perpendicular motion along a rail 11. In some embodiments, there are guide rollers 15 at the end along one of the short sides 14. Each of the guide rollers 15 may be a pair of rolling features at an angle. On the other short side of the tray 16, free rollers 17 are adapted to roll over the top of rail 12. The free rollers 17 may be horizontal rolling tube features. The free rollers 17 also may be of sufficient width to allow for slight deviations in the separation distance of the two rails 11, 12 with no interference of the rolling ability of the tray 10. The use of guide rollers on a first end of the tray and free rollers on the second end of the tray allows the trays to be easily rolled along the length of the rails while being well held laterally in position.

In some embodiments, the guide rollers 15 and the free rollers 17 are located at the corners of the tray 10 such that when empty trays are stacked the rollers 15, 17 protrude down into the space along the inside of the sides 14, 16, 18, 19 of the tray below snugly to limit or eliminate any lateral motion of stacked trays relative to each other. This feature may allow trays which are stored away from the trailer to utilize a minimum for storage.

In some embodiments, the trays are 4 feet by 8 feet by 8 inches high. In some embodiments, the sides of the trays are 6 inches high and the rollers protrude another 2 inches below the sides of the trays. In some embodiments, the trays are adapted to carry loads in the range of 600-1200 pounds without significant deflections.

In some aspects of the present invention, the trays may be used to support centralized nursery operations. In a greenhouse used for the growing of plants, plants of different types may be grown at different locations in the greenhouse. A retail outlet may place an order for a variety of plant types, with stated quantities of each variety. A tray, or a number of trays, may be transported through the greenhouse and the order may be placed into one or more trays. The trays may be pulled through the greenhouse using a driven transport with a trailer or trailers adapted to support one or more trays. As the transport is driven through the greenhouse, plants may be taken from different locations in the greenhouse and loaded onto the trays to fill various orders.

In some embodiments, the tray may be moved through the greenhouse on a rail system, which may be an automated system. The plants desired to be placed onto a tray may be placed upon the tray as it is transported through the area where the desired plants are grown.

Although described herein in terms of nursery operations, the equipment and methods described herein may be used for other types of operations.

In some embodiments, the trays may be loaded with goods destined for the same delivery location. The timing of the deliveries to locations along the delivery route may dictate how the trailer is loaded. Goods for delivery later in the delivery schedule may be loaded onto trays which are placed into the trailer first, while goods for delivery earlier in the delivery schedule may be loaded onto trays which are placed into the trailer last. This allows for entire trays to be removed at early delivery locations and to allow for those goods to be unloaded without disturbing the goods loaded for later delivery.

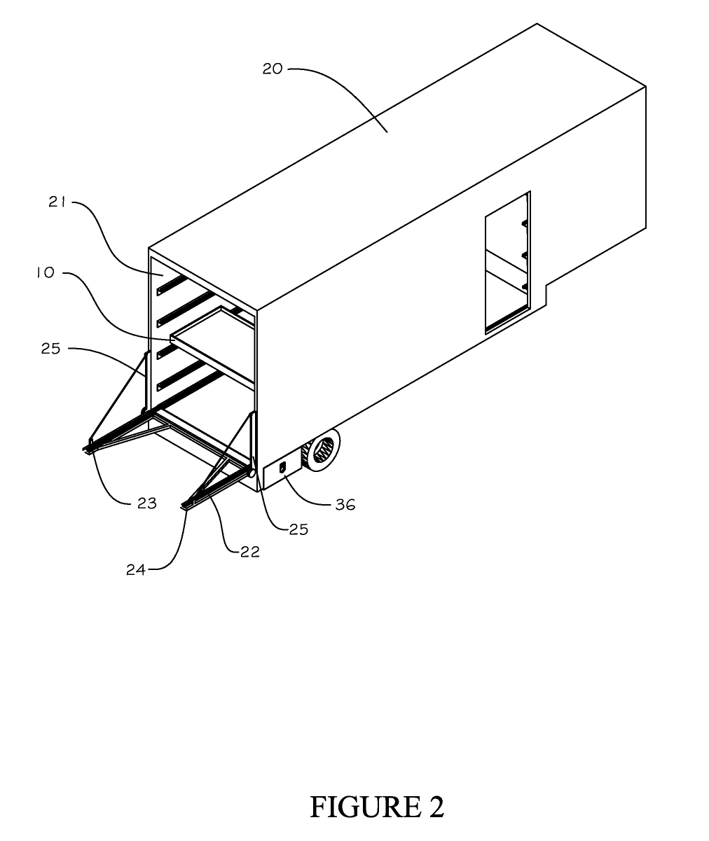

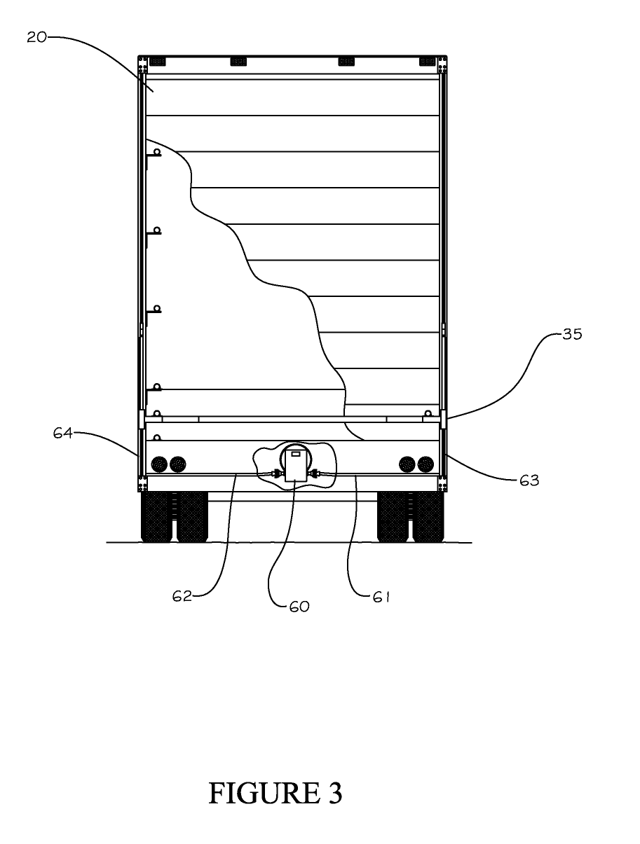

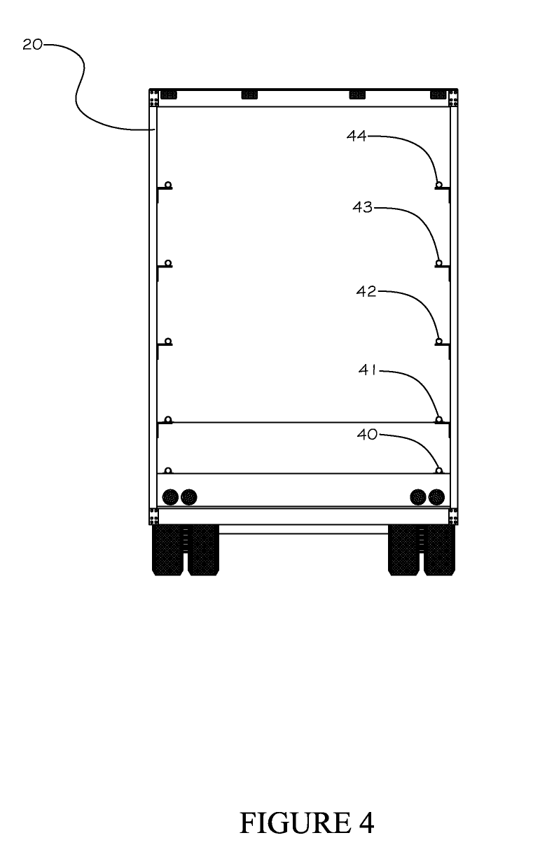

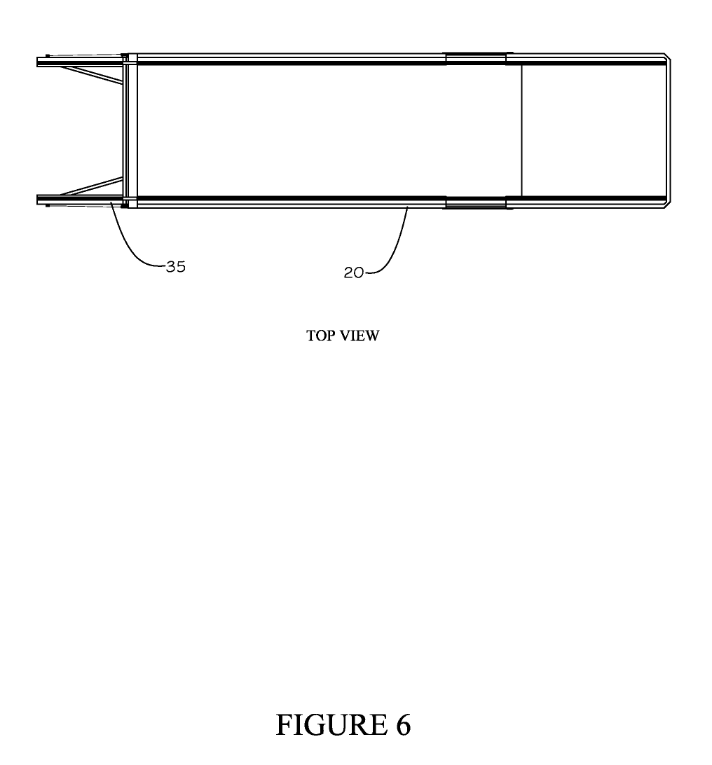

In some embodiments of the present invention, as seen in FIG. 2, a trailer 20 is adapted to transport trays 10. The trailer 20 is adapted to allow for more efficient use of its interior space 21, as well as more efficient loading and unloading. As seen further in FIGS. 3-6, the interior of the trailer 20 is adapted to receive rolling trays along a vertical range of heights using sets of interior rails 40, 41, 42, 43, 44 which are placed on opposite sides of the interior of the trailer at the same corresponding height. The interior rails may be attached to the interior sidewall of the trailer. The interior rails allow for the loading of trays into the trailer with significant ease relative to previous loading methods. For example, a tray may be loaded onto rails at a certain height at the rear end of the trailer and then it may be rolled further into the front of the trailer along the rails.

In some embodiments, the interior rails may be of cylindrical construction to allow for the easy rolling of trays which have guide and free rollers as describe above. The rails may be attached to structural supports attached to the inside of the trailer.

In some embodiments, the trailer may thus be loaded fully with efficient use of space, and also loads of relatively fragile items, such as plants, may be placed over each other without damaging the lower items in the trailer. In addition, the use of trays within the trailer which have been previously loaded with goods onto the trays greatly reduces the labor necessary to load a trailer, and also the time necessary to unload a trailer.

In some embodiments, the goods may be delivered with the tray, all of which is left at the delivery site. The goods may also be removed from the tray at the delivery site, and the tray put back into the trailer. In some embodiments, the tray is removed from its original site on the rails, and perhaps also from the trailer, and unloaded. The empty tray may then be reloaded at the top rail level in order to be out of the way of a subsequent rail's removal and unloading.

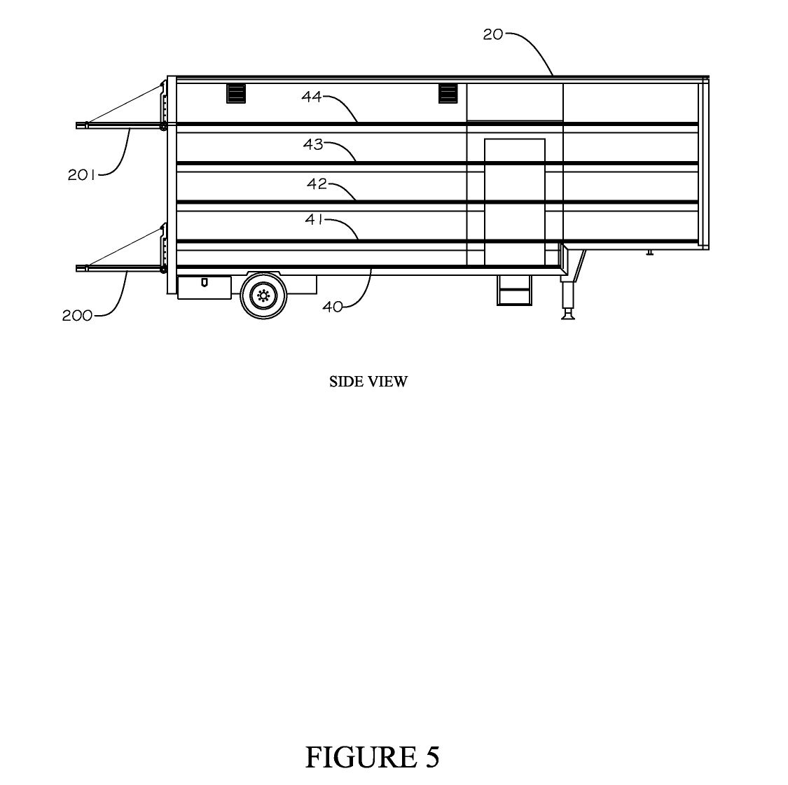

In some embodiments, the trailer 20 has a lift mechanism 22 adapted to facilitate loading of trays 10 into the trailer 20. The lift mechanism 22 may have lift rails 23, 24 which may accept a tray 10 and then lift the tray 10 to a desired height to align with one of the sets of interior rails 40, 41, 42, 43, 44. The lift rails 23, 24 may be adapted to fold down, and may adapted to load trays into the trailer at either a lower position or a higher position. Thus, as seen in FIG. 5, for unloading the lift rails may be at the height of the ground 200, such that the lift mechanism may unload trays nearly to ground level. The extended lift rails may be needed to access the upper portions of the trailer. The support structure 25 of the lift mechanism 22 may link the lift to a power unit 36 adapted to raise and lower the lift mechanism. The lift mechanism may also then raise the tray to a top height 201.

In some embodiments, a control system for the lift mechanism is adapted to raise the lift mechanism to pre-determined heights such that the lift rails 23, 24 are aligned with the sets of interior rails 40, 41, 42, 43, 44, allowing a tray that has been loaded onto the lift rails to be easily loaded into the interior space 21 of the trailer 20. In some embodiments, the power unit 36 is adapted to raise the lift mechanism and the trays loaded thereon. An electric motor 60 is adapted to drive a pair of horizontal drive axles 61, 62, which in turn rotate vertical power screws 63, 64. The rotation of the vertical power screws raises or lowers the set of lift rails, which may have drive nuts 35.

In some embodiments, the control system will allow an operator to select a rail set and the lift will go to that height. In some embodiments, the user will utilized a handheld or mounted control box to control the motion of the lift mechanism.

The lift mechanism may utilize a separate battery system such that the lift mechanism may be used regardless of whether the trailer is connected to a truck with its power system. The batteries may be stored in an accessible side compartment 36, and the control system controls, including a handset controller, may be stored in another accessible side compartment 37.

In some embodiments, the trailer is adapted to travel with the lift mechanism in a raised state, although not as high as seen in FIG. 5. The lift mechanism may be set at a height such that the lift rails 23, 24, when folded up along the rear of the trailer, do not extend above the top of the trailer. A clamping mechanism may securely clamp the lift mechanism in place, with the lift rails folded up, for travel.

With the combination of the railed lift mechanism and the interior rails, loading and unloading of the trailer is made significantly easier and less time consuming and labor intensive. In addition, if delivery orders are placed upon a tray or set of trays, the delivery of items may be reduced to removing the tray or trays for that delivery location from the trailer, without confusion about which items are to be delivered.

In some embodiments, the loading and unloading areas may have a rail system adapted to align with the lift rails of the trailer, such that when the trailer is loaded, the loaded trays may be rolled onto the lift rails of the lift mechanism, and then raised to the selected interior rails, and rolled into the trailer. Similarly, when unloading, the trays may be rolled out onto the lift rails which have been set to accommodate the desired interior rail set, and then lowered using the lift mechanism, and rolled onto a mating rail set at the drop-off location. Whether all or some of these aspects are used, the lifting of loaded trays by persons may not be necessary. The unloaded trays may be on the order of fifty pounds, which may be handled by persons.

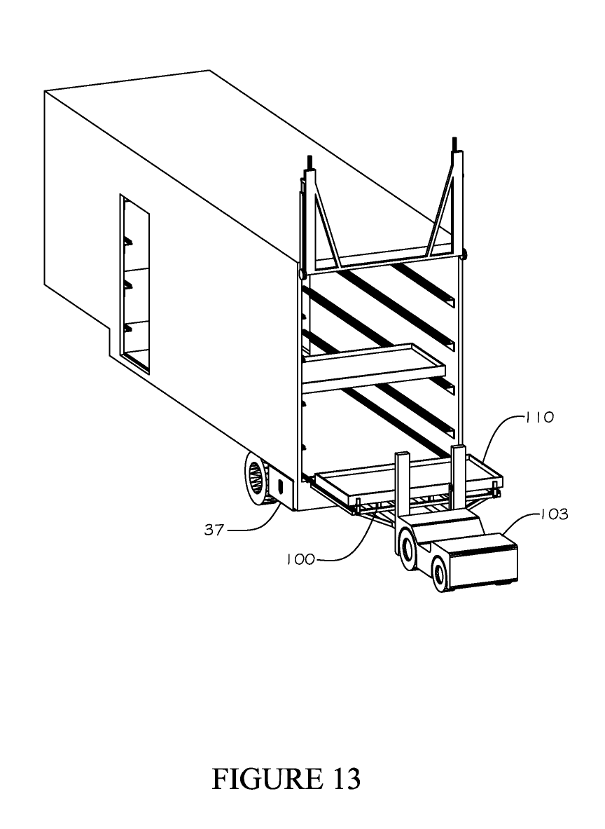

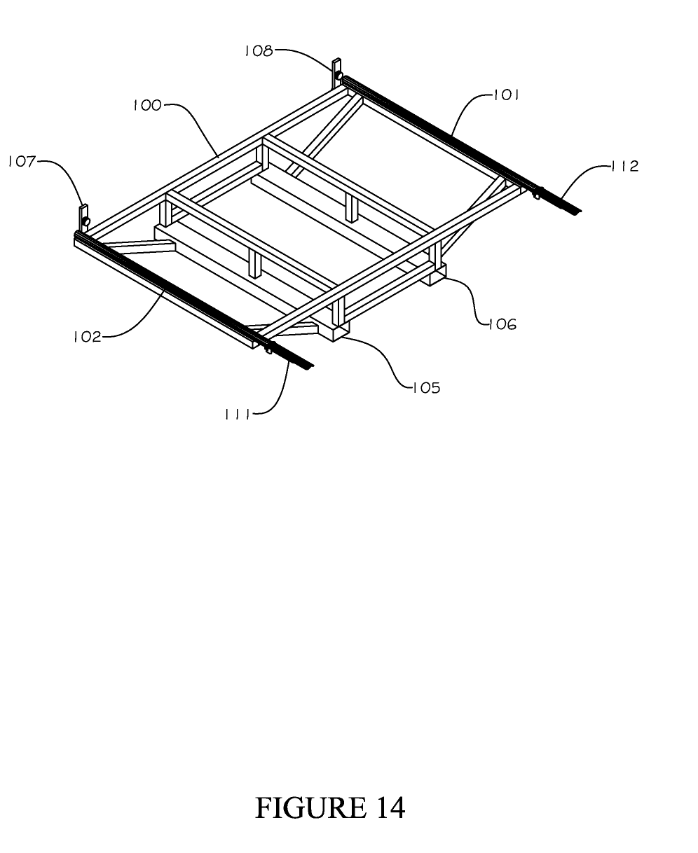

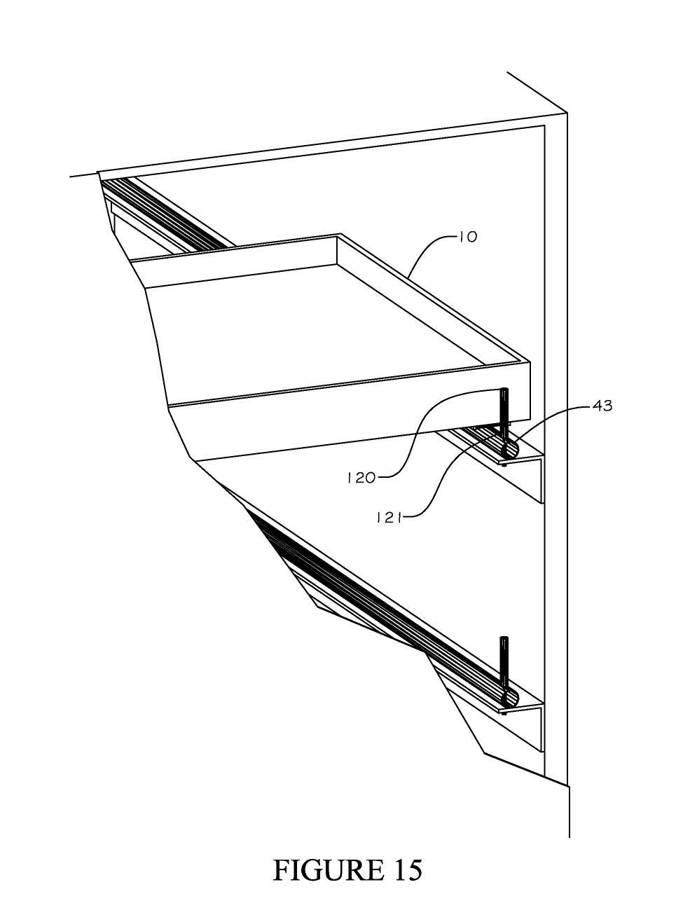

In some embodiments of the present invention, as seen in FIGS. 13 and 14, a loading frame 100 is used to load trays into the trailer. The loading tray 100 has a structural support for supporting two loading rails 101, 102. The loading frame 100 is adapted to mount onto the forks of a forklift with slots 105, 106. At the rear of the loading rails 101, 102 (the end facing the forklift), stops 107, 108 are adapted to prevent the tray from rolling backwards off of the rails. Guides 111, 112 are adapted to lay over the rails of the lift mechanism to effect a smooth transition from the loading frame 100 to the rails of the lift mechanism at the back of the trailer. FIG. 13 illustrates a forklift 103 loading a tray 110 with the use of a loading frame 100. The loading frame may be used to load the interior rails directly, or to load the lift mechanism of the trailer, as the user desires. The loading frame may utilize, in conjunction with the forklift, a rotator mechanism adapted to slightly rotate the loading frame to allow for proper alignment with the trailer. In some cases a slope adjuster may be used. In some use cases, the trailer and the ground outside of the rear of the trailer may be mis-aligned enough that some rotation is called for to allow the rails of the loading frame and the rails of the trailer to align for loading and unloading.

In some embodiments, the lift mechanism is shaped such that the structural supports of the lift mechanism are limited to the outside sides of the trailer such that a forklift with a loading frame is adapted to load the rails within the sides of the trailer even if the lift mechanism is in a lowered position. In such embodiments, the loading frame and the lift mechanism may be designed such that they do not physically interfere with each other when the lift mechanism is in the lowered position.

In order to maintain the positioning of a tray, as seen in FIG. 15, the trays may be held into position using a mechanical stop. A tray 10 may be maintained in position with the use of one or more stop pins 120 which may be inserted into holes 121 along an interior rail 43. The rails may have a series of holes along their length which allow the trays to be constrained in a variety of positions along the length of the rails. For example, if a set of rails is not filled all the way along its length with trays, the stop pins may constrain the trays such that they do not roll along the rails during transport. Also, the stop pins may prevent the trays from rolling out of the end of the trailer when not desired.

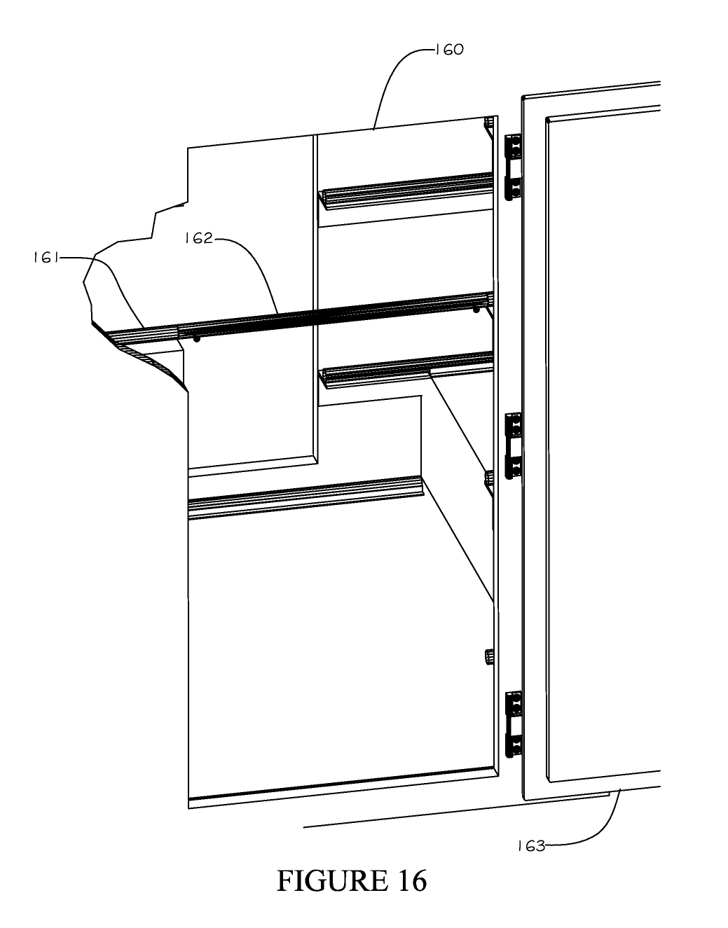

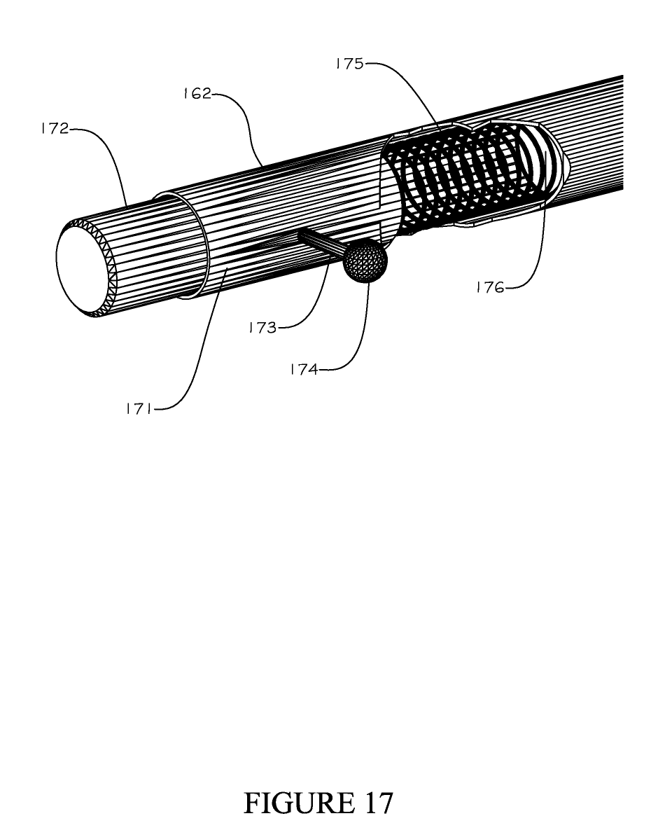

In some embodiments, as seen in FIGS. 16 and 17, the trailer may have removable rail sections along the interior length of the trailer such that side access doors may be opened and accessed with the removable rail sections removed. The side door 163 may be opened to expose an opening 160 in the side of the trailer. A plurality of removable rail section 162 may be installed along each of the interior rails 161 which traverse the opening 160. The removable rail sections 162 are adapted to fit into the gap in the interior rails. The interior rails may be tubular, with a retractable plug section 172 adapted to plug into the interior of the interior rail to extend the structural support of the rail across the opening. The retractable plug section 172 may have a pin 173, with handle 174, adapted to be slid by the user to compress a spring 175 within the removable rail section. The spring 175 may be constrained by an interior plug 176.

In some embodiments, the trailer may have a venting system such that air flows through the trailer while traveling. An inlet vent may be found at the front of the trailer with exhaust vents along each side of the trailer in some embodiments.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A system to aid in the loading and unloading of and delivery of goods from a trailer, said system comprising:
a trailer, said trailer comprising:
a first interior side;
a second interior side; and
a rear entryway;
a plurality of interior guide pairs at different vertical positions along the interior sides of said trailer, each of said plurality of interior guide pairs adapted to support one or more trays, wherein each of said plurality of interior guide pairs comprises:
a first interior guide attached to said first interior side of said trailer; and
a second interior guide attached to said second interior side of said trailer, wherein said first interior guide and said second interior guide of an interior guide pair are at substantially the same vertical height along the interior sides of said trailer, and wherein said first interior guide and said second interior guide are adapted support a flat tray in a horizontal position.

2. The system of claim 1 further comprising one or more trays, said one or more trays adapted to fit within said trailer, said one or more trays comprising a first end and a second end, said one or more trays adapted to reside horizontally on an interior guide pair while said first end rests upon a first interior guide and said second end rests upon a second interior guide of an interior guide pair.

3. The system of claim 2 wherein said first interior guide and said second interior guide of said interior guide pairs comprise tubes mounted horizontally along the length of the first interior side and the second interior side of the trailer.

4. The system of claim 3 wherein said trays comprise a first roller adapted to roll along said first interior guide and a second roller adapted to roll along said second interior guide.

5. The system of claim 4 further comprising a plurality of mechanical stops, said mechanical stops adapted to prevent to motion of one or more trays along the length of an interior guide.

6. The system of claim 4 wherein said mechanical stop comprises a pin adapted to be removeably placed in a hole along an interior guide.

7. The system of claim 2 further comprising a lift gate, said lift gate attached to said trailer, said lift gate adapted to move vertically along the rear entryway of said trailer.

8. The system of claim 7 wherein said lift gate comprises a gate guide pair, said gate guide pair comprising a first gate guide and a second gate guide, wherein said first gate guide and said second gate guide are horizontally spaced to line up with said interior guide pairs.

9. The system of claim 8 wherein said first gate guide and said second gate guide comprise tubes adapted to support said trays.

10. The system of claim 8 wherein said lift gate comprises a powered device adapted to raise and lower the lift gate.

11. The system of claim 10 wherein said lift gate is adapted to raise said lift gate from a first lowered position to a second position wherein said gate guides align horizontally with one of said interior guide pairs.

12. A system for shipping and delivery of goods, said system comprising:
a trailer, said trailer have interior sides and a rear opening;
support means for supporting trays in a horizontal attitude within the trailer; and
one or more trays adapted to be supported by said support means.

13. The system of claim 12 wherein said support means comprises a plurality of support means for supporting trays in a plurality of vertical positions within the trailer.

14. The system of claim 13 further comprising a lift means for loading and unloading trays by moving trays to and from said plurality of vertical positions.
